(19) United States
(12) Patent Application Publication
(10) Pub. No.: US 2006/0285958 A1
(43) Pub. Date: Dec. 21, 2006

(54) Roller bed trailer having width extension rollers

(76) Inventor: Robert C. Wilhelm, St. Mary's (CA)

Correspondence Address: EDWARD H. OLDHAM, 20 JAMESON DRIVE, DUNDAS, ON, L9H 5A2, CA

(21) Appl. No.: 11/378,687

(22) Filed: Mar. 20, 2006

Related U.S. Application Data
(60) Provisional application No. 60/688,789, filed on Jun. 9, 2005.

(51) Int. Cl. B60P 1/00

(52) U.S. Cl. 414/529

(57) ABSTRACT

A set of retractable roller assemblies are mounted in the framework of a transport vehicle having a roller bed. The retractable roller assemblies are mounted between the main load carrying rollers of the roller bed. In this instance the retractable rollers may be manually pulled out of the transport frame to give an extension of about two feet to the width of the transport. The roller extension devices may be power actuated as well to provide the additional width for carrying over width loads. The roller assemblies may be provided on both sides of the transport bed.

### FIELD OF INVENTION

This invention relates to roller beds for transports and in particular to retractable roller extensions for increasing the width of the transport bed for carrying wide loads.

### BACKGROUND OF THE INVENTION

Transports, that is, standard trucks and semi trailered vehicles, having roller beds have been used to carry particular types of loads for some period of time. The loads which are most amenable to transport and unload using roller beds are trusses, wall panels, pallets and lumber, where the load tends to be fairly robust and may be unloaded by rolling the load off the transport as a package or several discrete packages.

It is not unusual for the load bearing rollers of the transport body to extend the entire width of the transport (usually about eight and one half feet) or the rollers may also be segmented so that a plurality of rollers may be say, used to extend the width of the transport.

This application will deal with the transport and unloading of suitable freight from semi trailers but the invention may apply to standard truck bodies equipped with rollers as well.

The rollers of the transport vehicles of this invention may be locked or unlocked during transport of the load to its destination but of course will be unlockable to permit freedom to rotate during the unloading process. The locking and unlocking operation may be performed pneumatically, hydraulically or manually depending on the application.

In use, the load, say trusses are loaded onto the transport (usually by a forklift vehicle) at the factory. It will be found that the load is usually bound together in such a manner that the load will respond as a unitary entity or as several discrete packages. When the load has been secured on the trailer and the rollers are locked, the load is secured in place by suitable binding devices and the tractor trailer proceeds to the load's destination.

Upon arrival at the designated destination, the binding means is removed from the load, the rollers unlocked, and the trailer may be elevated at the forward end to increase the slope of the trailer bed in order to encourage the load to roll off the trailer. (In some instances the trailer wheels may be moved forward under the trailer body to lower the rear end of the trailer.) When the load begins to shift the transport is driven forward and if the unloading operation is successful, the entire load will roll off the trailer without any breakage occurring during the unloading operation. If the load on the trailer consists of several individual packages, they will roll off, one package at a time in a series type of operation.

### SUMMARY OF THE INVENTION

This invention is concerned with the transport of freight which is “over width” and suitable for a “roll off” unloading operation. The load referred to in this application will have a width which must be supported up to and over a distance of ten feet.

To accomplish this, roller extensions are provided between the main rollers comprising the trailer bed which may be “pulled out” of the trailer side to provide additional load carrying width to the transport trailer. These rollers may be lockable (to prevent rotation) or they may not, but they are slidably mounted in the trailer chassis. The roller assemblies will be stored the retracted position in the transport body until they are required.

### PRIOR ART

U.S. patents
U.S. Pat. No. 6,799,933
U.S. Pat. No. 6,681,535
U.S. Pat. No. 6,401,096
U.S. Pat. No. 6,200,082
U.S. Pat. No. 5,921,742
U.S. Pat. No. 5,478,190
U.S. Pat. No. 5,324,160
U.S. Pat. No. 5,211,413
U.S. Pat. No. 5,201,286
U.S. Pat. No. 4,679,979
U.S. Pat. No. 4,690,608
U.S. Pat. No. 4,919,445
U.S. Pat. No. 3,967,743
U.S. Pat. No. 3,967,743
U.S. Pat. No. 5,417,539

### BRIEF DESCRIPTION OF THE DRAWINGS

FIG. 1 shows an elevational view of a transport trailer of the prior art;

FIG. 2 is a plan view of the transport trailer of FIG. 1;

FIG. 3 is a perspective of a tractor trailer showing the present invention;

FIG. 4 is a perspective view of an enlargement of the roller extension of this invention.

### DESCRIPTION OF THE PREFERRED EMBODIMENT

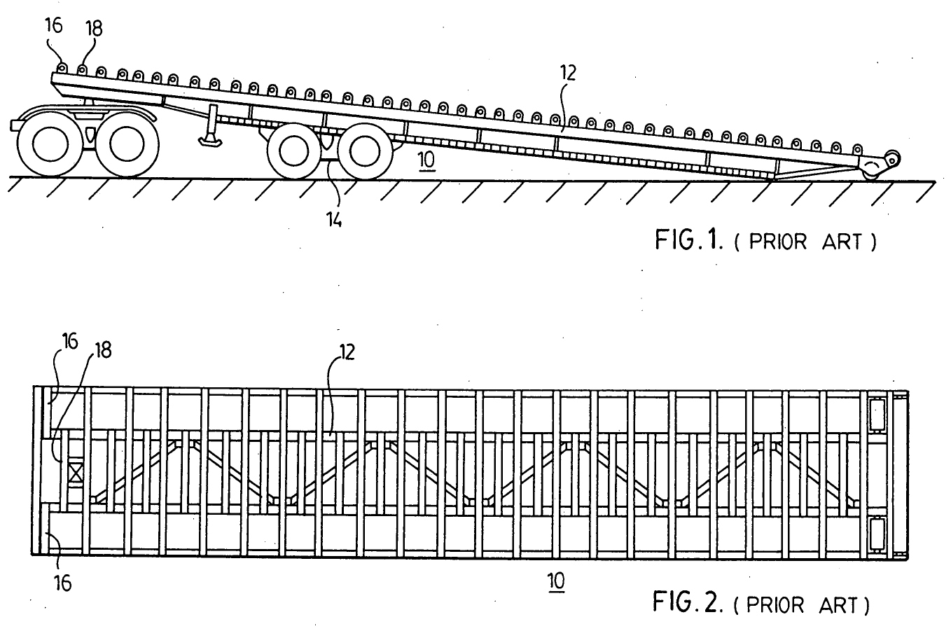

Referring to prior art trailer 10 of FIG. 1, it will be seen that trailer 10 has a chassis 12 to which a suitable axle assembly 14 is fastened. In this instance the axle assembly may be moved on chassis 12 for ease of unloading the freight carried by trailer 10 but this feature is ancillary to this invention.

The surface of trailer 10 comprises a series of rollers for supporting the load to be placed upon the trailer 10. Rollers 16 support the load at the outside edges of trailer 10 and rollers 18 support the load in the center of the trailer 10. FIG. 2 shows the location of rollers 16 and 18 more clearly.

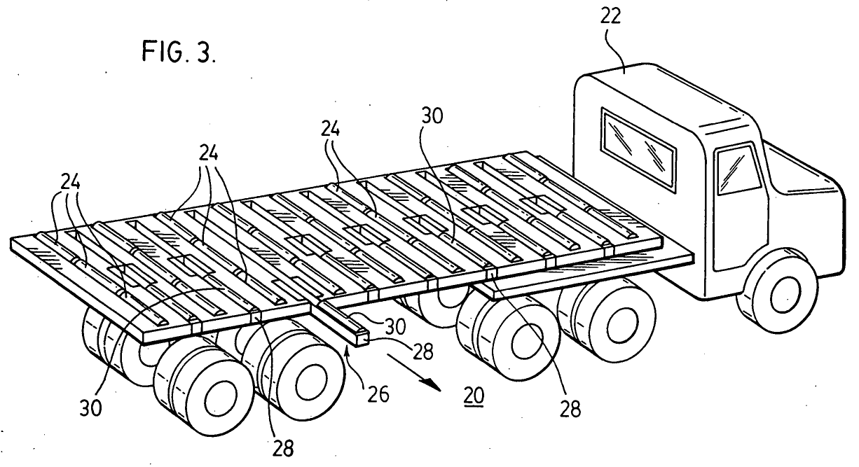

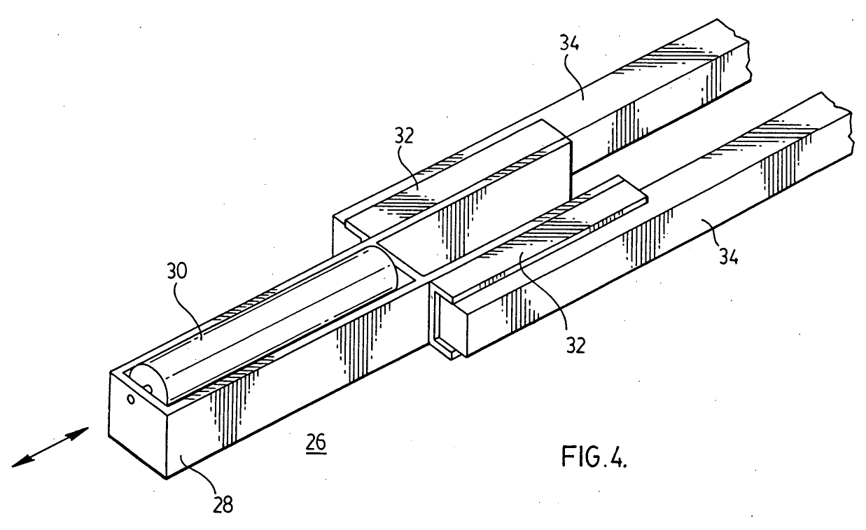

FIG. 3 is an illustration of a semi trailer 20 embodying the applicant's invention. Semi trailer 20 is attached to tractor 22 in the usual manner and comprises a series of load carrying rollers 24 extending across the width of the trailer. In this instance, three rollers 24 are shown at each station, but a single roller extending the entire width of the trailer 20 may function equally well.

Shown extending between each group of rollers 24 are extension roller devices 26 which comprise a frame 28 and roller 30. In this instance the extension roller assemblies 26 are made to be slidably mounted in the trailer frame 20 and may be retracted when not in use. It will be seen from FIG. 2 that there is generally enough space between the roller assemblies to mount each additional set of extendable roller assemblies 26 for this invention.

FIG. 4 shows an enlarged perspective of this invention. Here roller 30 is shown rotatably mounted in frame 28.

Attached to frame 28 are a pair of channels 32 which are slidably mounted on rectangular supports 34. These channels provide the roller assemblies 26 with the ability to slide in and out of the frame of trailer 20 and carry a suitable load when required. The roller assembly will be provided with a stop to limit the maximum lateral movement of roller assembly 26 out of the frame of trailer 20.

Suitable locks are provided to secure the extensions 26 in their retracted position.

The rollers 30 may be lockable if desired. It is believed that the roller extensions 26 will be usually located on the passenger side of the trailer.

In this instance, roller assemblies 26 are shown as slidable entities which are slid in and out of the trailer body. The roller assemblies 26 may also be pivoted in the trailer body so that they may be pivoted from a storage position to a load carrying position to increase the width of the trailer to ten feet or more if desired. When not in use the roller extensions may be retracted so that the width of the trailer will revert to eight and one half feet in width.

It will be appreciated that the various regulatory authorities may require an escort vehicle for commercial vehicles transporting over width loads. Thus whilst an escort vehicle may be required when the roller assemblies are extended to carry an over-width load, no escort is required during the return trip when the roller assemblies are retracted.

It is believed that there may be other methods of providing retractable roller assemblies (which may be powered as well) on roller beds, will come to the mind of one skilled in the art having the benefit of the teachings presented in the foregoing descriptions and the associated drawings. Therefore, it is to be understood that the invention is not to be limited to the specific embodiments disclosed, and that the modifications and embodiments are intended to be included within the scope of the dependent claims.

What is claimed:

1. In a transport vehicle used for hauling freight which is intended to be rolled off the vehicle at the load destination, a series of rollers mounted across the transport bed to carry the load and assist in the unloading operation,
an additional set of retractable rollers mounted between rollers mounted in the vehicle which may be deployed to carry loads of width in excess of said bed.

2. In a transport trailer having a roller bed for carrying freight of a nature which may be rolled off said trailer at a destination,
the roller bed comprising a first series of rollers which may be locked during periods of transport and extending the width of the trailer,
a secondary set of roller assemblies mounted between said first series of rollers on said bed which may be deployed to support freight having a width in excess of eight and one half feet.

3. A transport vehicle as claimed in claims 1 or 2 in which said rollers may be locked to prevent rotation.

4. A method of supporting a load having excessive width on a roller transport vehicle comprising:
providing a transport vehicle having a roller bed of standard width, wherein a first series of rotatable rollers support the first portion of said load on said bed,
said first series of rotatable rollers having means to prevent rotation of said rollers during a transport operation,
providing a second set of rollers which may be moved from a stored position between the rolls of said first series of rotatable rollers, to a load carrying position extending beyond the standard width of said bed to carry the remaining portion of said load.

5. A method of supporting a load as defined in claim 4 in which said second series of rollers are slidable between said stored position to said load carrying position.

6. A method of supporting a load as claimed in claim 3 in which said second series of rollers are pivotable from said stored position to said load carrying position.
